(19) United States
(12) Patent Application Publication
(10) Pub. No.: US 2011/0100235 A1
(43) Pub. Date: May 5, 2011

(54) TRASH COMPACTOR

(75) Inventors: Dustin Hrubetz, Lake Mills, IA (US); Nancy Peterson, Albert Lea, MN (US); Eric Willey, Albert Lea, MN (US); Rob Fjelbroten, Albert Lea, MN (US); William S. Dea, Bloomington, MN (US)

(73) Assignee: Fountain Industries Co.,, Albert Lea, MN (US)

(21) Appl. No.: 12/795,880

(22) Filed: Jun. 8, 2010

Related U.S. Application Data
(60) Provisional application No. 61/268,136, filed on Jun. 8, 2009.

(51) Int. Cl. B30B 15/00; B30B 7/00; B30B 9/00

(52) U.S. Cl. 100/35; 100/233; 100/99

(57) ABSTRACT

The present disclosure provides a trash compactor and methods of compacting trash. In an embodiment of the present disclosure the compactor is configured to automatically actuate an integrated hydraulic unit that is configured to both pivot a multi-sectioned crush plate and also to lower the plate into a base member. Related methods of compacting are also provided.

### RELATED APPLICATIONS

This application claims priority to U.S. Provisional Application No. 61/268,136 filed on Jun. 8, 2009 titled Trash Compactor, which is incorporated by reference in its entirety herein.

### TECHNICAL FIELD

The present disclosure relates to a method and apparatus for compacting trash.

### BACKGROUND

Processing trash is generally more efficient when the trash is compacted.

This is especially the case when the trash is compacted near the location at which the trash is collected. Some trash compactors that are configured to compact trash near the location that the trash is collected (as opposed to at a landfill) are known. For example, see U.S. Pat. No. 5,517,907 as well as compactors that are commercially available from Fountain Industries Co. of Albert Lee, Minn. (i.e., Compactor Model 1800, 2400, 3600).

Improved compacting methods and apparatuses (e.g., configuration having high ratio of compaction resulting in less frequent unloading and less total trips to the landfill, improved configurations resulting in smaller/lighter units that draw less power, improved configurations having automated sensing and communication functions, etc.) are desirable.

### SUMMARY

The present disclosure provides a trash compactor and related methods of compacting trash (the term trash as used herein is intended to mean any material to be compacted such as waste, refuse, etc.). In one embodiment of the present disclosure the compactor is configured to automatically actuate an integrated hydraulic unit that is configured to both pivot a multi-part crushing plate and also to lower the multi-part crushing plate into a base container for compacting. Related methods of compacting are also provided.

### BRIEF DESCRIPTION OF THE FIGURES

FIG. 1 is a perspective view of an embodiment of the compactor according to the present disclosure;

FIG. 2 is a perspective view of the compactor of FIG. 1 with portions of the housing shown in a partially open position;

FIG. 3 is a perspective view of the compactor of FIG. 1 with the housing removed showing the compacting assembly in a retracted position;

FIG. 4 is a perspective view of the compactor of FIG. 1 with the housing removed showing the compacting assembly in an intermediate position;

FIG. 5 is a perspective view of the compactor of FIG. 1 with the housing removed showing the compacting assembly in an extended position;

FIG. 6 is a perspective view of a portion of the compacting assembly of the compactor of FIG. 1;

FIG. 7 is a side view of a portion of the compacting assembly of the compactor of FIG. 1; and

FIG. 8 is a front view of a portion of the compacting assembly of the compactor of FIG. 1.

### DETAILED DESCRIPTION

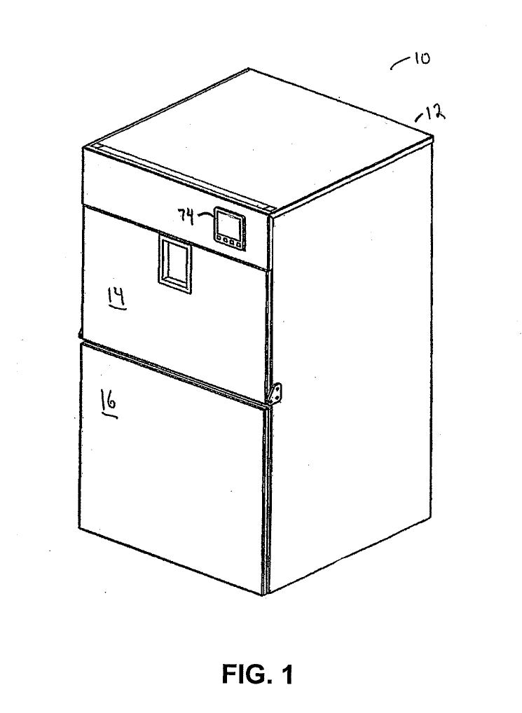

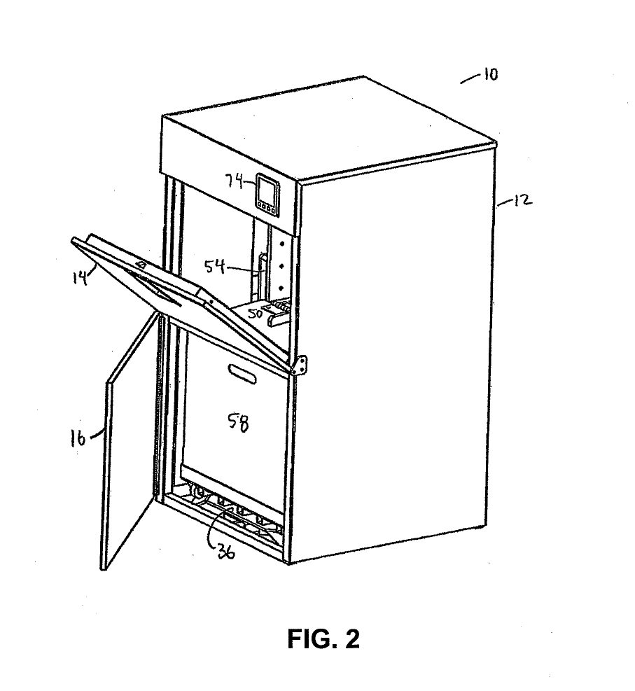

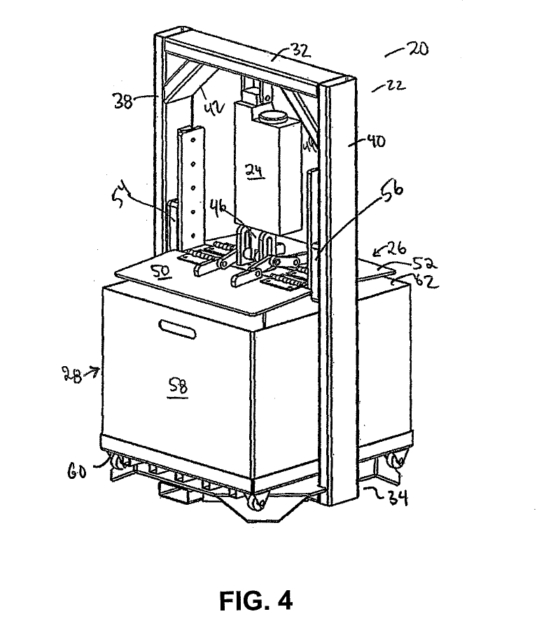

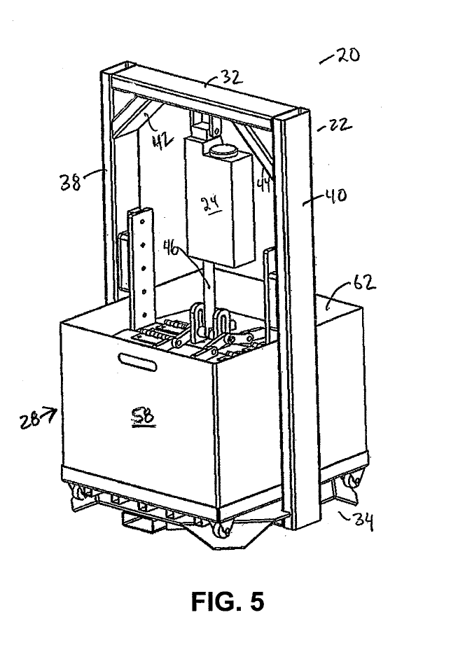

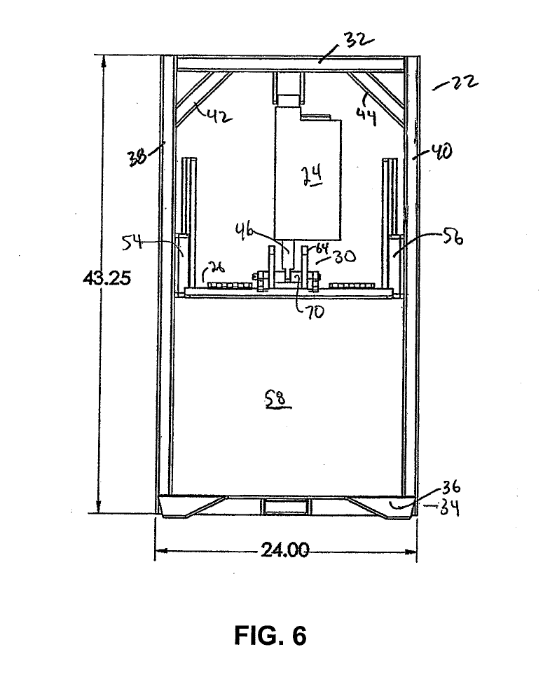

Referring to FIGS. 1-8 an embodiment of the present disclosure is shown. In the depicted embodiment, the compactor 10 includes a housing 12, also referred to as a cover or shroud. In the depicted embodiment the housing 12 has a door 14 that can be opened to load the compactor 10 with trash by pivoting the door 14 about a horizontal axis, and a drawer 16 that can be opened so that the compacted trash can be removed from the compactor 10 by pivoting the drawer about a vertical axis.

In the depicted embodiment the compactor 10 is sized and configured so that it could be used in place of a standard trash receptacle for on-site trash collection and compacting (e.g., the compactor 10 in the depicted embodiment can be used in a fast food restaurant in place of a commonly used 50 gallons trash receptacle). However, it should be appreciated that the principles of the present invention can be applied in many other contexts as well. For example, the compactor 10 can be used to compact bags of trash collected from multiple standard trash cans that do not have integrated trash compacting functionality.

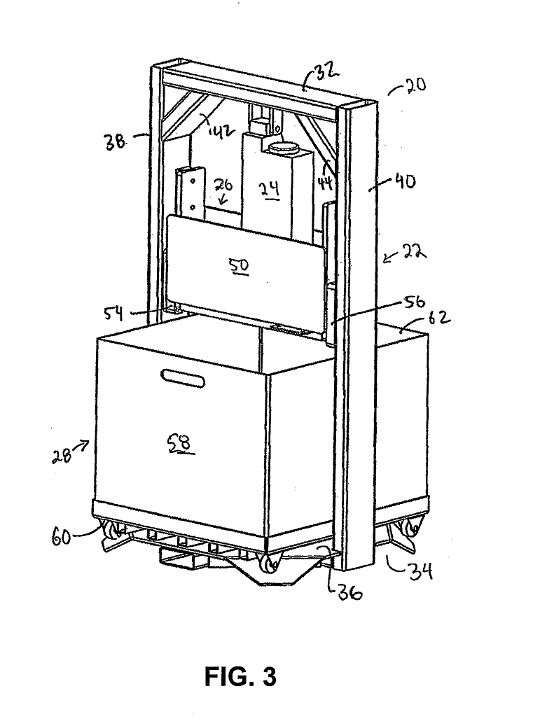

Referring more particularly to FIGS. 3-6, the compactor 10 is shown with the housing 12 removed to expose the compacting assembly 20. In the depicted embodiment the compacting assembly includes a frame 22, a hydraulic device 24 connected to the frame 22, a crushing device 26 connected to the frame 22, a base container 28 positioned within the frame 22, and a linkage assembly 30 connected between the crushing device 26 and the hydraulic device 24.

In the depicted embodiment, the frame 22 includes a generally horizontal upper member 32 (e.g., a piece of metal tubing having a rectangular cross-section), a base 34 for supporting the base container 28 (e.g., metal tubing covered by a metal plate), and two opposed, generally vertical, longitudinal members 38, 40 that connect the upper member 32 to the base 34. In the depicted embodiment a pair of gussets 42, 44 are connected between the upper member 32 and the longitudinal members 38, 40 for auxiliary structural support. In the depicted embodiment the frame is about 43 inches tall and 24 inches wide. The depth of the frame 22 at the upper end of the frame is less than 12 inches (e.g., about 6 inches wide) and the depth of the frame 22 at the bottom end of the frame about 24 inches (depth of base 34). In the depicted embodiment the frame 22 is constructed of steel that has been treated to prevent corrosion (galvanized, painted, etc.). However, it should be appreciated that the frame 22 could instead be constructed of many other types of materials.

In the depicted embodiment the frame 22 is configured such that the stresses and strains caused by the compacting of trash are generally contained within the frame itself and not imparted onto the housing 12. In the depicted embodiment, the crushing action applies a force to the inside surface of the upper member 32 via the hydraulic device 24 and top surface 36 of the base 34 via the base container 28. The crushing force results in stresses and strains in the longitudinal members 38, 40, upper member 32, base, and gussets 42, 44. Since the housing 12 is not needed for structural support of the crushing assembly 20, the housings can be of a variety of designs and constructions. For example, the housing can comprise a lightweight construction that includes multiple sheets of plastic connected together, it can be of a single molded plastic piece, and/or it can be designed to be interchangeable. The disclosed configuration results in a relatively lightweight compactor (e.g., total weight less than 300 pounds). It should be appreciated that other configurations and sizes are also possible.

In the depicted embodiment, the hydraulic device 24 includes a pump, motor, and shaft 46 all of which are at least partially contained within a single enclosed housing. In the depicted embodiment the motor is a 12 volt permanent magnet type motor, the pump has a fluid capacity of 21 cubic inches, and the shaft 46 is 304 stainless steel having a stroke length of between 5-12 inches. An example of a suitable hydraulic device 24 is the commercially available Model 7050 Hydraulic Actuator available from Cook Manufacturing Corporation, which is typically used as a steering component for a motorize boat. In the depicted embodiment the hydraulic device 24 is configured to be powered via a variety of power sources (e.g., 115 alternating current-15 amp power source or a 12 direct current power source, etc.)

In the depicted embodiment, the crushing device 26 includes a center member 48 slidably connected to the frame 22, a first plate 50 pivotally connected to the center member 48, and a second plate 52 pivotally connected to the center member 48. In the depicted embodiment, the center member is a generally rectangular structure positioned directly below the shaft 46 and includes two opposed ends that are each slidably connected to the longitudinal members 38, 40 of the frame via slider 54, 56 (e.g., gib blocks, tongue and groove configuration, roller bearing configurations, etc.). The sliding connection between the opposed ends of the center member 48 and the frame 22 minimizes deflection of the crushing device 26 (e.g., twisting) during use. In the depicted embodiment, the plates 50, 52 are connected to the frame 22 via their connection to the center member 48 rather than directly to the frame 22.

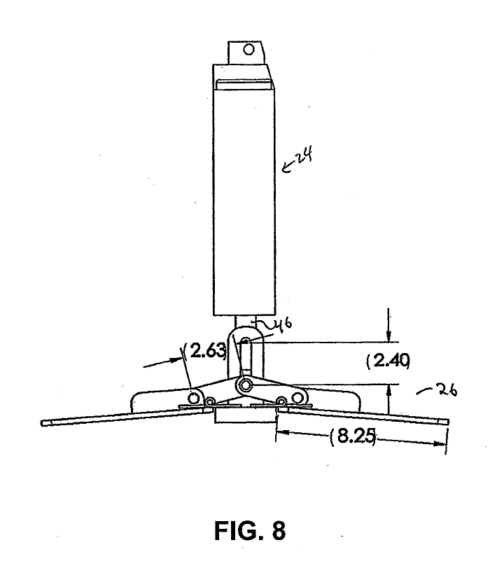

In the depicted embodiment, the first plate 50 of the crushing device 26 is hinged along a longitudinal edge of the center member 48, and the second plate 52 is hinged along a longitudinal edge of the center member 48. In the depicted embodiment, each of the first and second plates has a pivot range of about 80-110 degrees relative to the center member 48. In particular, the plate member when the shaft 46 is fully retracted is oriented generally vertically and when extended (when crushing) is oriented past horizontal. In other words, the plate members 50, 52 when in the crushing position are oriented at an angle that is less that 180 degrees relative to each other (see FIG. 8). Accordingly, the trash being crushed is guided towards the center of the base container 28 by the plates 50, 52 which results in the crushing forces primarily being in the vertical direction and aligned with the shaft 46. In the depicted embodiment, both of the plates 50, 52 move in synchronization due to the movement of the shaft 46 (extension and retraction). Accordingly, the forces applied to both plates 50, 52 and back from the plates 50, 52 are generally balanced.

In the depicted embodiment, the base container 28 includes a side wall 58 and a bottom wall 60. The base container 28 is removable from the housing 12 and includes an upper opening 62 sized and configured to receive the crushing device 26. In the depicted embodiment, when the upper opening 62 is aligned to receive the crushing device 26, the bottom wall 60 of the base container is positioned over the top surface 36 of the base 34 of the frame 22. Although in the depicted embodiment the base container 28 is generally cubed shaped, it should be appreciated that many other shapes are also possible (e.g., cylindrical). In the depicted embodiment the base container 28 includes a sealed body construction. The sealed body prevents the contents (compacted trash) within the base container 28 from leaking out from the compactor 10 while avoiding the need for trash bags. It should be appreciated that many other alternative configurations are also possible.

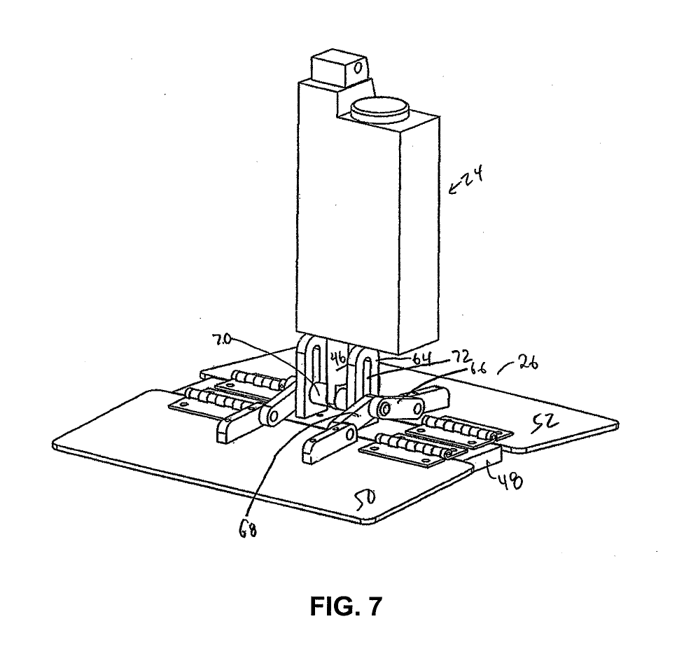

In the depicted embodiment, the linkage assembly 30 includes a first member 64 slidably connected to the end of the shaft 46 and connected to the center member 48, a second member 66 pivotally connected to the shaft 46 and pivotally connected to the first plate 50 and, a third member 68 pivotally connected to the shaft 46 and pivotally connected to the second plate 52. In the depicted embodiment a pin 70 that extends perpendicularly through the shaft 46 is received within a slot 72 in the first member 64 and pivotally connected to the second and third members 66, 68. In the depicted embodiment, the linkage assembly 30 includes two identical halves, wherein each half includes a first member, a second member, and a third member. The pin 70 connects both sets of first members, second members, and third members to the shaft 46 (see FIG. 7).

In the depicted embodiment, the linkage assembly 30 is connected to the hydraulic device 24 and crushing device 26 such that the extension of the shaft 46 causes the first and second plates 50, 52 to pivot downwardly and also causes the crushing device 26 to move downwardly into the base container 28. In the depicted embodiment the shaft 46 is connected to the center member 48 such that the shaft can extend and retract the length of the slot 72 without displacing the center member 48. On the other hand, movement of the shaft 46 causes movement of the plates 50, 52 (either pivoting or displacing upwards/downwards). The movement of the shaft 46 that does not cause the center member 48 to move corresponds to the movement of the shaft that pivots the plates 50, 52. As discussed above, the linkage assembly 30 is configured to transfer the downwardly directed force (crushing force) equally/symmetrically on the plates 50, 52. The linkage assembly 30 is also configured to pivot the plates 50, 52 so that when the plates are in the up/raised position they are out of the path of the trash as it enters the compactor thereby avoiding the trash being caught above the crushing device 26. The wide pivot range enabled in part by the linkage assembly 30 is also desirable as it allows for easy service and maintenance of the compactors. In the depicted embodiment the first member 64 having the slot therein is between 2.0 to 3.0 inches long and the distance between pivot points on the second and third members 66, 68 is each between 2.0 to 3.0 inches long. However, it should be appreciated that many other configurations are also possible.

In the depicted embodiment, the compactor 10 includes a control unit 74. The control unit 74 in the depicted embodiment is configured to actuate the hydraulic device automatically after the door is open a predetermined number of times. In the depicted embodiment the compacting ratio of the compactor can be adjusted. For example, the compacting ratio can be adjusted from 0-20, meaning that the compactor can be configured to decrease the volume of the trash by zero of its uncrushed volume (thereby functioning as a standard trash receptacle) up to one-twentieth of its uncrushed volume.

In the depicted embodiment the control unit 74 automatically notifies an operator when trash in the base container exceeds a predetermined level. For example, the control unit 74 automatically emails or text messages an operator when trash in the base container exceeds a predetermined level indicating that the compactor should be unloaded. In some configurations the user can query the control unit 74 remotely and determine how much trash is in the compactor 10. In addition, the control unit 74 is configured to automatically notify (e.g., audibly via speaker on the unit, audibly via a phone call, or via text through sending an email or text message) when the trash receptacle needs maintenance or repair and the type of maintenance or repair that is required. In the depicted embodiment the control unit 74 includes some of the hardware and software features commercially available in the XL Series Operator Control Station sold by Horner APG, LLC (www.hornerOCS.com). It should be appreciated that other components and other types of voice or data networks could also be used.

In the depicted embodiment, the compactor 10 is configured such that the door 14 of the housing 12 is prevented from being open when the crushing device 26 is not in the raised position. The compactor 10 can also be configured such that when the door 12 is open, the motion of the crushing device 26 is stopped.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A trash compactor comprising:
a compacting assembly including:
a frame;
a hydraulic device connected to the frame, the hydraulic device including a shaft that is configured to extend and retract;
a crushing device, the crushing device including:
a center member slidably connected to the frame;
a first plate pivotally connected to the center member;
a second plate pivotally connected to the center member;
a base container including an upper opening sized and configured to receive the crushing member;
a linkage assembly connected to the shaft of the hydraulic device and connected to the first and second side plates such that the extension of the shaft causes the first and second plates to pivot downwardly and causes the crushing device to move downwardly into the base container and wherein retraction of the shaft causes the first and second plates to pivot upwardly and causes the crushing device to move upwardly.

2. The trash compactor of claim 1, wherein the hydraulic device includes a pump, motor, and shaft all of which are at least partially contained within a single enclosed housing.

3. The trash compactor of claim 1, further comprising a non-metallic housing that shrouds the frame.

4. The trash compactor of claim 1, further comprising a control unit that actuates the hydraulic device automatically after the door is open a predetermined number of times.

5. The trash compactor of claim 1, further comprising a control unit that automatically notifies an operator when trash in the base container exceeds a predetermined level.

6. The trash compactor of claim 1, further comprising a control unit that automatically emails an operator when trash in the base container exceeds a predetermined level.

7. The trash compactor of claim 1, wherein the linkage assembly includes a pin that is attached to an end of the shaft, a slotted member that receives the pin connected to the center member, a first arm that is pivotally attached to the pin and pivotally attached to the first plate, and a second member that is pivotally attached to the pin and pivotally attached to the second plate.

8. The trash compactor of claim 7, wherein the slotted member includes a slot that is between 2.0 to 3.0 inches long, wherein the first arm is between 2.0 and 3.0 inches long between pivot points therein and the second arm is between 2.0 and 3.0 inches long between pivot points therein

9. The trash compactor of claim 1, wherein each plate has a pivot range of at least 90 degrees.

10. The trash compactor of claim 1, wherein each plate has a pivot range of at least 110 degrees.

11. The trash compactor of claim 1, wherein the crushing device is configured such that when it moves downwardly into the base container, the plates are at an angle that is less than 180 degrees from each other.

12. The trash compactor of claim 1, wherein the frame includes a base and the base container is configured to be supported over the base of the frame.

13. The trash compactor of claim 1, wherein with exception to the base of the frame the overall depth dimension of the frame is less than half of the overall width dimension of the frame.

14. The trash compactor of claim 1, wherein the frame includes an upper member, a base, and two opposed vertical members connecting the upper member to the base, wherein the frame is configured such that the stresses and strains caused by the actuation of the hydraulic member are contained within the frame and not imparted on the housing.

15. A method of compacting trash comprising:
providing a trash receptacle having a door for receiving trash, wherein the trash receptacle includes an automated trash compacting assembly therein;
manually unloading the trash receptacle based on an automated signal generated by and sent from the trash receptacle.

16. The method of claim 15, wherein the trash receptacle is configured to sense the amount of trash therein.

17. The method of claim 15, wherein the trash receptacle is configured to identify when the trash receptacle needs to be emptied.

18. The method of claim 17, wherein the trash receptacle is configured to automatically send an email notification when the trash receptacle needs to be emptied.

19. The method of claim 15, wherein the trash receptacle is configured to automatically send an email notification when the trash receptacle is in need of maintenance or repair.

20. A trash compactor comprising:
a housing;
a compacting assembly;
a frame, the frame including:
an upper member;
a base;
a first and a second longitudinal members connecting the upper member to the base;
a hydraulic device including a shaft that extends and retracts from an enclosed housing, wherein the housing includes at least a hydraulic pump and a electric motor therein;
a crushing device including:
a center member having a first and second end, the ends being slidably connected to the first and the second longitudinal members of the frame;
a first side plate hinged along a longitudinal edge of the center member;
a second side plate hinged along a longitudinal edge of the center member;
a linkage assembly including:
a first member slidably connected to the end of the shaft and connected to the center member;
a second member pivotally connected to the shaft and pivotally connected to the first side plate and;
a third member pivotally connected to the shaft and pivotally connected to the second side plate;
a base container including a side wall and a bottom wall, wherein the base container is removable from the housing and includes an upper opening sized and configured to receive the crushing device, and wherein when the upper opening is aligned to receive the crushing device, the bottom wall of the base container is positioned over the base of the frame.
